(19) United States
(12) Patent Application Publication
(10) Pub. No.: US 2008/0111689 A1
(43) Pub. Date: May 15, 2008

(54) METHOD AND APPARATUS FOR COMMUNICATION WITH A TRANSPORT STRUCTURE IN TRANSIT

(75) Inventors: Francesca Schuler, Des Plaines, IL (US); Thomas S. Babin, Lake Zurich, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/558,528

(22) Filed: Nov. 10, 2006

(51) Int. Cl. G08B 13/14; H04K 1/00; G06F 7/00

(52) U.S. Cl. 340/572.1; 705/50; 707/100; 707/E17.005

(57) ABSTRACT

A method and apparatus for communicating with goods transported in a container by a carrier. New information to be transmitted is stored in a database of the carrier. When the container is in proximity of a communication node of the carrier, the carrier communication node transmits the new information to the intelligent device of the container. The container intelligent device of the container then communicates the new information to a second intelligent device associated with the transported goods. The second intelligent device then stores the new information and/or transmits it to an RFID tag of the transported goods. The new information may be encrypted for secure communication.

### CROSS-REFERENCE TO RELATED APPLICATIONS

This application is related to U.S. patent application Ser. No. 11/323,546, attorney docket number CML02604T, entitled “Method and System for Request Processing in a Supply Chain”, filed Dec. 30, 2005; to U.S. patent application Ser. No. 11/323,516, attorney docket number CML02553T, entitled “Method For Resource Management in a Supply Chain”, filed Dec. 30, 2005; U.S. patent application Ser. No.______, attorney docket number CML02730T, entitled “Method and Apparatus for Supply Chain Management Using Pallet-Workstation and Workstation-Workstation Communication”, filed even date herewith, each and assigned to the assignee hereof.

### BACKGROUND

In order to facilitate loading, unloading and packing, goods are commonly transported using standardized structures, such as pallets and containers. A pallet is a flat transport structure, usually made of wood or plastic (and in a few cases metal and paper), which can support a variety of goods in a stable fashion while being lifted by a mobile forklift or other jacking device. The goods are placed on top of the pallet, and can be secured to it by straps or stretch-wrapped plastic film. One example of a standard pallet measures 100 by 120 by 12 cm and can carry a load in excess of 1,000 kg.

Shipping containers also conform to a standard size and are used for the transport of nearly all goods. Containers offer the clean, level surfaces needed to make pallet movement economical. Additionally, a number of common ISO standard pallets fit neatly into a common ISO container, which in turn fits neatly on container ships, trains and trucks.

Pallets and containers are used to transport goods from a distribution site or manufacturing site to other sites for further processing or to retail sites. A single container may contain pallets from several different manufacturers or distributors.

One approach to tracking the transport of pallets is the use of bar codes. A bar code on the transported goods may be scanned by the carrier are various locations along the delivery route. The bar code contains limited information. The information retrieved by scanning the bar code may be stored in a database and accessed over a network, such as the Internet.

A further approach is the use of Radio Frequency Identification (RFID) tags or transceivers. Radio Frequency Identification (RFID) is an automatic identification method, relying on storing and remotely retrieving data using devices called RFID tags or transponders. An RFID tag is an object that can be attached to or incorporated into a product or pallet for the purpose of identification using radio waves. Chip-based RFID tags may contain silicon chips and antennas. Passive tags require no internal power source, whereas active tags require a power source.

When an RFID tag passes through an electromagnetic zone, it detects the reader's activation signal. A tag reader decodes the data encoded in the tag's integrated circuit (such as the product ID number) and the data is passed to a host computer. Data may also be written to the memory of the RFID tag.

A source (such as the manufacturer or distributor) may want to communicate with pallet make information queries regarding the shipment (projected arrival time, quantity of product coming, product type, etc.) or to update or change information (such as destination of shipment, pricing information, arrival time, etc.). However, current systems do not enable a source to communicate securely with the pallet or product while they are in transit.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagrammatic representation of a system for secure communication between a communication node and a pallet in transit in a container in accordance with some embodiments of the invention.

FIG. 2 is a diagrammatic representation of a system for secure communication between a communication node and a pallet in transit in a container in accordance with further embodiments of the invention.

FIG. 3 is a diagram of an exemplary database, in accordance with certain embodiments of the invention.

FIG. 4 is a sequence diagram depicting an exemplary series of communications in a system for secure communication with a pallet in transit in a container, in accordance with certain embodiments of the invention.

FIG. 5 is a diagrammatic representation of a loaded pallet in a container in accordance with certain embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to communication with transported goods. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of the intelligent devices and communication nodes described herein. The non-processor circuits may include, but are not limited to, a radio receiver, a radio transmitter, signal drivers, clock circuits, power source circuits, and user input devices. As such, these functions may be interpreted as a method to perform the operations described. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

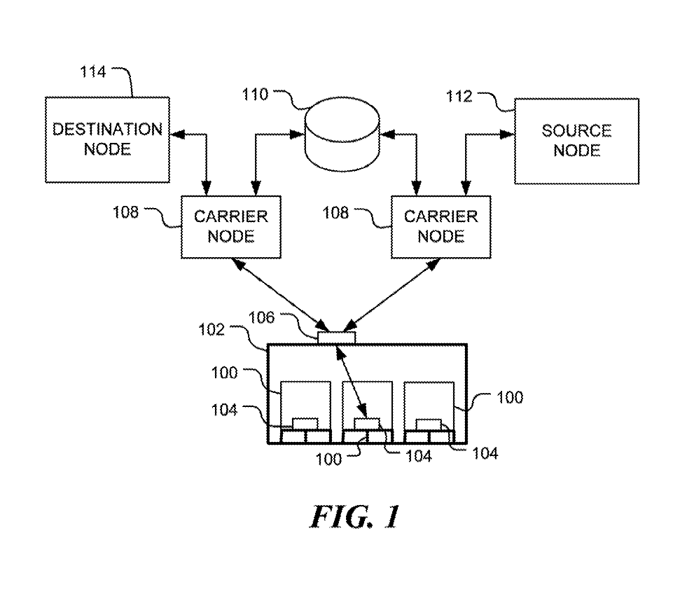

FIG. 1 is a diagrammatic representation of a system for secure communication between a shipping, or receiving, station and a pallet in transit in a container. A number of pallets 100 are carried in a shipping container 102. A pallet may be any kind of shipping structure, such a flat structure or box-like structure. A pallet of the present invention includes an intelligent device, such as a radio frequency, identification (RFID) tag 104, located on the pallet 100 (either directly on the pallet, or on the transported goods). The intelligent device may be an electronic device including a processor, a transponder and a memory. The intelligent device may be active or passive.

A further intelligent device 106 is located on the container 106 and is operable to communicate with the pallet intelligent device 104.

The container is transported by a carrier that operates air, sea and/or land vehicles to move the containers. The carrier maintains a number of carrier communication nodes 108 that are operable to communicate with the intelligent device of the container. These communication nodes may be located at transportation hubs, for example. The carrier communication nodes have access to a database 110 that is used to store information regarding the container and its contents.

The container intelligent device 106 may communicate with the pallet intelligent devices 104 to determine their identities. These identities may, in turn, be communicated to a carrier node 108 and used to update the database 110.

When a container 102 is in communication range of a carrier communication node 108, the node communicates with the intelligent device 106 of the container and causes it to update the memories of pallet intelligent devices 104 within the container using data from the database 1 10. Alternatively, the pallet intelligent device may communicate the information to a RFID tag on an item carried by the pallet. Since the carrier is often a different entity to the shipper and/or receiver of the goods, the data may be encrypted so that it is only useful to a particular shipper and/or receiver.

The pallet intelligent device may update its information in response to detected events. For example, an event could be a change in a sensed value, a time-related condition, receipt of a wireless message, or a sensed value meeting a criterion. Examples of sensed values include, but are not limited to, weight, physical location, temperature, pressure and chemical presence. Examples of time-related conditions include, but are not limited to, a periodic condition, a duration of time elapsed since the occurrence of some other event, and a real time value, such as 3:35 PM. Examples of receipt of a wireless message include, but are not limited to, a message from another pallet device, a message from a workstation device and a message from a server.

When the pallet is in transit, the intelligent device of the pallet may be accessed by communication nodes of a party other than the carrier. For example, the communication nodes may be operated by the shipper and/or receiver of the transported goods. This is achieved by the non-carrier communication nodes querying or updating the database 110. The database may used to update the memory of a pallet intelligent device. Additionally, the non-carrier communication node can request that the database be updated by querying the pallet intelligent device when it is next within range of a carrier communication node.

When a container is within range of a carrier communication node, a non-carrier communication node may communicate with the intelligent device 104 of a pallet via the carrier communication node with or without updating the database 110.

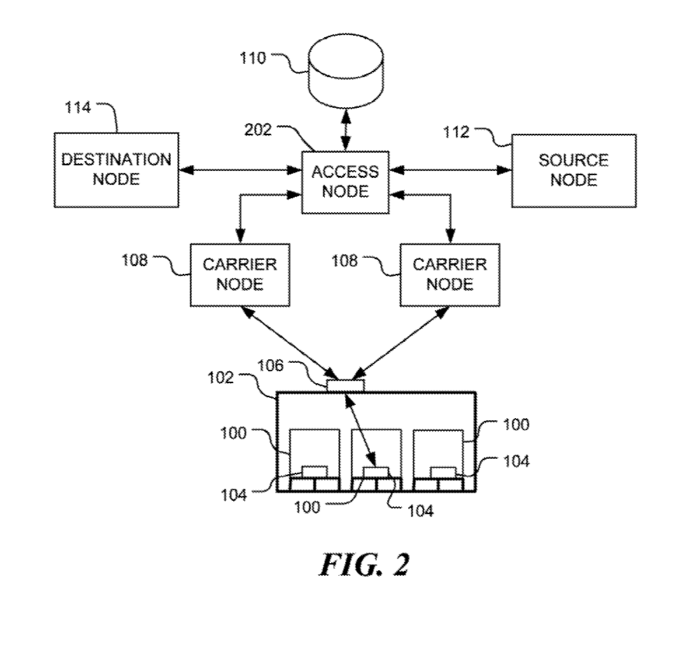

FIG. 2 is a further diagrammatic representation of a system for secure communication between a shipping, or receiving, station and a pallet in transit in a container. In this system, an access node 202 facilitates communication with the database 110. The non-carrier nodes and the carrier nodes all communicate with the access node to obtain access to the database. The access node may be a secure node that denies database to unauthorized users and limits access to others users depending upon their access rights. For example, a manufacturer may only be allowed access to database entries relating to that manufacturer's pallets. The access node may be accessed via the Internet or other network.

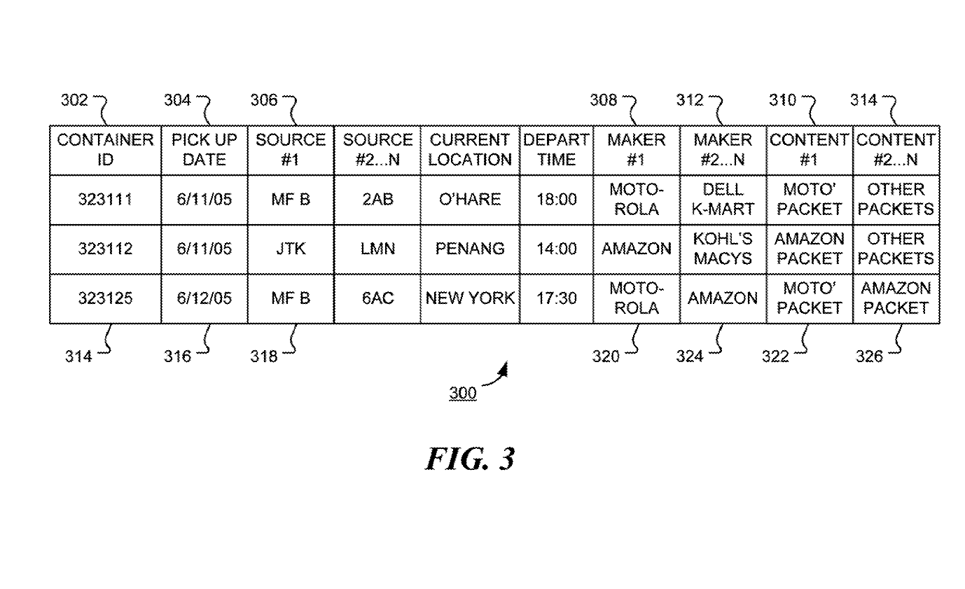

FIG. 3 is a diagram of an exemplary database, consistent with certain embodiments of the invention. The database table 300 contains a number of fields (302, 304, 306, 308, 310, 312 and 314 for example). The field 302, for example, indicates the identifier of a particular container. Fields 304 and 306, etc., relate to the container, while fields 308, 310, 312 and 314 relate to the contents of the container. Field 308, for example, identifies the manufacturer (company ‘A”, company ‘B’, etc) of a particular pallet in the container. Associate field 310 contains data relating to that pallet. This information may be generated by the manufacturer or shipper, for example. The information may be encrypted so that it is not accessible to the carrier or other shippers.

Since the container may contain pallets from multiple manufacturers additional fields 312 are included in the database, together with fields 314 for associated information content.

The columns of the database table 314, 316, 318, 320, 322, 324 and 326 for example, contain the actual data. Data in columns 322 and 326 may be encrypted to prevent access to confidential information by unauthorized parties.

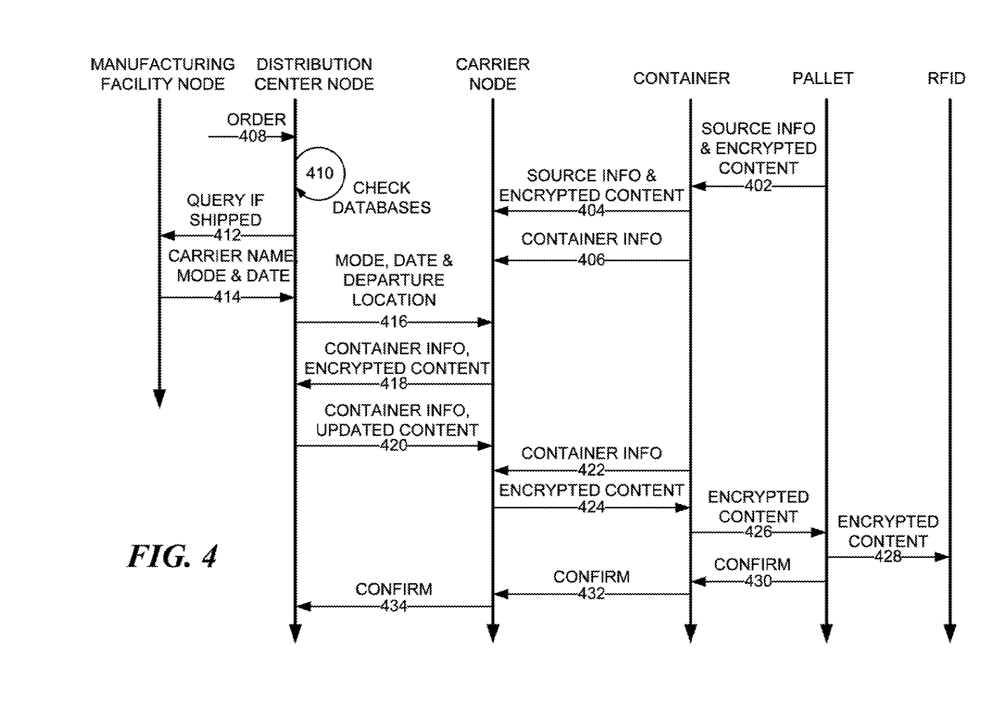

FIG. 4 is a sequence diagram depicting an exemplary series of communications in a system for secure communication of information between a non-carrier node and a pallet in transit in a container. In this example, the non-carrier node is operated by a distribution center. However, it will be apparent those of ordinary skill in the art that the communication system allows other information exchanges to take place. The vertical lines in FIG. 4 denote time lines, with time increasing in the direction of the arrows. Referring to FIG. 4, when a pallet is loaded into a container, an intelligent device on the pallet communicates at 402 with an intelligent device on the container. This communication may include, for example, the source of the pallet, the contents of the pallet and also encrypted information concerning the contents of the pallet. This information may be obtained by the intelligent device on the pallet from RFID tags on items carried by the pallet (this communication is not shown in FIG. 4). The container intelligent device communicates the information to a local carrier port or hub at 404. Also, at 406, the container information, such as the container ID, is passed to the carrier. The carrier uses the container information and pallet information to update a central database.

At 408, the distribution center receives an order request for a product of type ‘A’, say. The distribution center checks receiving and inventory databases and distribution center floor databases at 410. If the order cannot be fulfilled, the distribution center queries one more manufacturing centers at 412 to determine if product type ‘A’ has been shipped. If product of type ‘A’ has been shipped, the manufacturing center responds at 414 with, for example, the name of the carrier, the mode of shipping and the date the product was shipped.

At 416, the distribution center tells the carrier the source of the product, the date shipped and the departure location. This enables the carrier to query the central database and retrieve the corresponding container and pallet information, including encrypted information. This information is passed to the distribution center at 418. If the carrier node is local to distribution center, an RF communications means could be used for communication. For longer distances, information could be communicated over the Internet, for example, and data stored or queried via the database.

The distribution center decrypts the information and is able to discover which container is carrying product type A. The distribution center can then update the information (for example, the order ID and destination for an RFID of product type ‘A’). The distribution center encrypts the information content and sends it back to the carrier at 420. The carrier then updates the central database with the new encrypted data.

In this example the distribution center is the source of the new information that is to be passed to the pallet. In other applications, the new information may be generated anther source, such as the manufacturer or a third party.

When the container arrives at the next carrier port or hub, the container information is passed at 422 to a carrier node at the hub. The carrier can then update the database with the new location of the container. In FIG. 4, it is to be understood that the time lines of a number of carrier nodes have been combined for ease of display.

The local carrier detects that encrypted information for this container has been updated in the database, and the carrier port transmits the updated information to the container intelligent device at 424. At 426, the updated information is passed to the intelligent devices of one or more pallets in the container. A first pallet intelligent device receives the information and checks to see if product of type ‘A’ is on the pallet, using the RFID tags on the products. If the pallet intelligent device finds product type ‘A’ on the pallet, it writes the updated information to the RFID at 428 and informs other pallet intelligent devices (of the same manufacturer or shipper) that the information has been updated (other pallets not shown). The pallet intelligent device then confirms the success (or failure) of the operation to the intelligent device of the container at 430, which in turn informs the carrier node at 432. Finally, the carrier node confirms the operation to the distribution center node at 434.

The container may hold several pallets, from the same manufacturer, each holding the same product types. Depending on the particular request, query or update, the container queries all pallets of that manufacturer and passes along the product update information. Several different scenarios can occur in response the information. These are considered for an example in which the request is to update 30 products of type A. Firstly, if 2 pallets both have 30 products of type A, one pallet makes a claim for the update, informs the other pallets that it is making the update, and then confirms with the container. Secondly, if 1 pallet has 10 products of type A and 1 pallet has 20 products of type A, both pallets make the update and confirm with one another and the container. Thirdly, if no pallets have products of type A, the pallets query one another and decide that the update can't be made and inform the container. In all cases, the container reports the outcome to the carrier database.

When the pallet arrives at the distribution center, the type ‘A’ product is already allocated to a specific order and is already logged into a database. This eliminates the need for receiving and inventory processes, since the processing has been performed in transit. In addition, the product may spend less time in inventory.

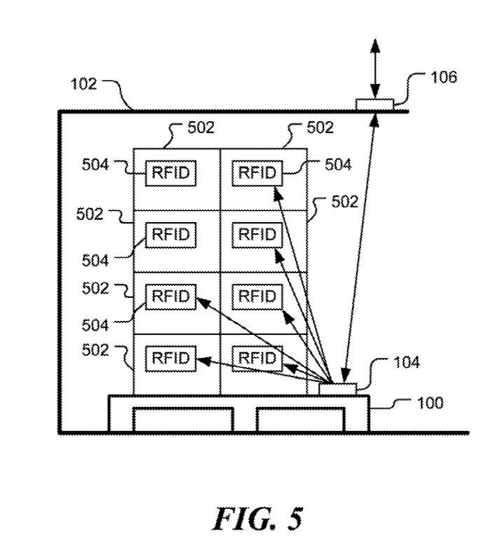

FIG. 5 is a diagrammatic representation of a loaded pallet 100 in a container 102. In this embodiment, an intelligent device 104 is located on the pallet 100 and is able to communicate with a further intelligent device 106 located on the container 102. The pallet supports the goods 502 being transported. It is to be understood that the term pallet is used to describe any structure that facilitates the transport of single or multiple items, and is take to include boxes, crates etc. The goods may be manufactured products, components, raw materials etc. The pallet intelligent device 104 is also able to communicate with radio-frequency identification (RFID) tags 504 attached to the individual items 502 of the transported goods. This communication may take place when the pallet is first loaded, when the pallet intelligent device is contacted by the container intelligent device 106, when the pallet is unloaded or at other times during transit. The RFID tag includes computer readable memory that may be used to store information relating to the single item to which it is attached. The RFID tag may be passive or active.

Additionally, the pallet intelligent device may include a computer readable memory that is readable by a processor of the intelligent device and may be used to store information relating to the pallet (and its history) and the goods on the pallet. The information may include, for example, the total number of products on the pallet, the weight of product, the types of products and the total number of products of each type. The memory may also be used to store software instructions for control of the intelligent device.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A system for communication with a pallet in a container of a carrier, the system comprising:
a first intelligent device located on the pallet;
a second intelligent device located on the container and operable to communicate with the first intelligent device;
at least one carrier communication node operable to communicate with the second intelligent device;
a non-carrier communication node operable to communicate with a carrier communication node of the at least one carrier communication nodes; and
a database accessible by the carrier communication node and operable to store encrypted data to be communicated between the first intelligent device and the non-carrier communication node via the second intelligent device and the carrier communication node.

2. A system in accordance with claim 1, wherein
the non-carrier communication node is operable to encrypting data, from one or more data packets containing the encrypted data and an identifier of the pallet and transmit the data packets to a carrier communication node of the at least one carrier communication nodes;
wherein the carrier communication node is operable to update the database in accordance with the data packets and to transmit the encrypted data to the second intelligent device; and
wherein the second intelligent device is operable to transmit the encrypted data to the first intelligent device.

3. A system in accordance with claim 2, wherein the first intelligent electronic device comprises a memory operable to storing the encrypted data.

4. A system in accordance with claim 2, further comprising a radio-frequency identification (RFID) tag attached to an item carried by the pallet, wherein the first intelligent device is operable to transmit the encrypted data to the RFID tag.

5. A system in accordance with claim 2, further comprising a plurality of radio-frequency identification (RFID) tags each attached to an item carried by the pallet, wherein the first intelligent device is operable to read information stored on the plurality of RFID tags, determine aggregate information therefrom and store the aggregate information on a memory of the first intelligent device.

6. A method for transmitting new information to a computer readable memory associated with goods transported in a container by a carrier, the method comprising:
storing the new information in a database;
when the container is in proximity of a communication node of the carrier:
an intelligent device of the container communicating its identity to the communication node of the carrier;
the carrier communication node querying the database to determine if new information is available for the container;
the carrier communication node transmitting the new information to the intelligent device of the container; and
the container intelligent device of the container communicating the new information to an intelligent device associated with the transported goods;
the intelligent device associated with the transported goods storing the new information in the computer readable memory.

7. A method in accordance with claim 6, wherein the computer readable memory is a memory of a radio-frequency identification tag attached to the transported goods.

8. A method in accordance with claim 6, wherein the intelligent device associated with the transported goods is located on a pallet supporting the transported goods.

9. A method in accordance with claim 8, wherein the computer readable memory is a memory of the intelligent device associated with the transported goods.

10. A method in accordance with claim 8, further comprising:
a generator of the new information transmitting the information to a communication node of the carrier; and
the communication node of the carrier storing the new information in the database.

11. A method in accordance with claim 10, further comprising:
the generator of the new information querying the carrier for information related to the transported goods;
the carrier communicating the information related to the transported goods to the generator of the new information; and
the generator of the new information generating the new information dependent upon the information related to the transported goods.

12. A method in accordance with claim 10, wherein the generator of the new information is a receiver of the transported goods, the method further comprising:
the receiver of the transported goods querying the source of the transported goods to determine the identity of the carrier.

13. A method in accordance with claim 10, further comprising the generator of the new information encrypting the new information before it is transmitted to the carrier communication node.

14. A method in accordance with claim 6, further comprising:
the intelligent device associated with the transported goods recovering information from radio-frequency identification tags attached to the transported goods;
the intelligent device associated with the transported goods communicating the information recovered from radio-frequency identification tags to the container intelligent device; and
the container intelligent device communicating the information recovered from radio-frequency identification tags to a communication node of the carrier.

15. A method for transmitting information from a computer readable memory associated with a transported item in a container by a carrier, the method comprising:
a first intelligent device located on a pallet supporting the transported item reading information stored in a computer readable memory on a radio-frequency identification (RFID) tag attached to the transported item;
the first intelligent device transmitting the information to a second intelligent device located on the container;
the second intelligent device transmitting the information and its own identity to a first communication node of the carrier; and
the first carrier communication node storing the information in a database of the carrier.

16. A method in accordance with claim 15, wherein the information is encrypted.

17. A method in accordance with claim 15, further comprising:
an communication node to an information recipient requesting information associated with the transported item from the carrier;
the carrier retrieving the information from the database; and
a second carrier communication node transmitting the information to the information recipient.

18. A method in accordance with claim 15, wherein the pallet supports a plurality of transported items, further comprising:
the first intelligent device reading information stored in a computer readable memory on radio-frequency identification (RFID) tags attached to the plurality of transported items.

19. A method for monitoring items transported in a container by a carrier on behalf of a second party, the method comprising:
a first intelligent device located on a pallet supporting the transported item detecting a change in the transported items;
the first intelligent device reading information stored in a computer readable memory on a radio-frequency identification (RFID) tag attached to the transported item;
the first intelligent device transmitting the information to a second intelligent device located on the container;
the second intelligent device updating a database of the carrier; and
the carrier alerting the second party.

20. A method in accordance with claim 19, further comprising the first intelligent monitoring a sensor associated with the pallet to detect the change in the transported items.
